(19) United States
(12) Patent Application Publication
(10) Pub. No.: US 2009/0217197 A1
(43) Pub. Date: Aug. 27, 2009

(54) SCREEN DATA PROCESSING APPARATUS, SCREEN DATA PROCESSING METHOD, AND COMPUTER PROGRAM

(75) Inventor: YOSHINORI SHINDO, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/371,964

(22) Filed: Feb. 17, 2009

(30) Foreign Application Priority Data
Feb. 27, 2008 (JP) 2008-046900

(51) Int. Cl. G06F 3/048

(52) U.S. Cl. 715/800

(57) ABSTRACT

A screen data processing apparatus is provided. The apparatus includes processing units, a generation unit configured to generate screen data on a processing unit basis in which an execution situation of each processing unit is drawn as a pattern, a display unit configured to display the screen data, a selection unit configured to allow selection as to which screen data generated on a processing unit basis is to be displayed on the display unit, a detection unit configured to detect an event occurring in each processing unit, and a determination unit configured to determine whether a processing unit corresponding to the screen data being displayed on the display unit matches a source processing unit of the event. When the determination unit determines a mismatch, the generation unit generates reduced screen data, and the display unit displays the reduced screen data combined with a portion of the screen data being displayed.

### BACKGROUND OF THE INVENTION

1. Field of the Invention

The present invention relates to displaying screen data in an apparatus that performs a plurality of processing steps.

2. Description of the Related Art

In an apparatus in which a plurality of controls simultaneously progress, such as a semiconductor manufacturing apparatus, it has been appreciated as an important issue to properly and quickly recognize the control-progressing state in the apparatus at the occurrence of an unexpected problem. This is because the proper and quick recognition enables a reduction in the scrappage rate of in-process materials and increases the operating efficiency of the apparatus.

Japanese Patent Laid-Open No. 11-121360 proposes a technique for properly recognizing the control-processing state. A semiconductor exposure apparatus includes a screen output unit that draws a pattern providing visual recognition of the state of a wafer being exposed and outputs the pattern as screen information. This pattern is drawn in synchronization with an actual exposure situation based on the exposure situation sent to a console in real time.

Japanese Patent No. 3031888 discloses the following method. Rather than drawing the control-progressing state, a still image of a site shot at the time of detection is recorded each time detection is performed in a control apparatus. Meanwhile, a moving image showing the current state of the shot site is displayed until specific overview data is designated.

In a semiconductor manufacturing apparatus, in most cases, a plurality of units cooperate to perform predetermined overall processing. For example, a typical semiconductor exposure apparatus is composed of a plurality of units such as an illumination system, a transport system, a reticle stage drive unit and a wafer stage drive unit, and an alignment detection system. The illumination system emits laser light used as exposure light. The transport system transports a reticle or wafer. The reticle stage drive unit and the wafer stage drive unit movably hold the reticle or wafer. The alignment detection system aligns the reticle and the wafer relative to each other. Each of these units is appropriately controlled by a CPU of the semiconductor exposure apparatus to perform a series of exposure processing steps.

To properly operate such a semiconductor exposure apparatus, a console unit serving as an I/O device for input to/output from the CPU needs to be used to display the control-progressing state of each unit as appropriate and provide suitable control instructions. Since the amount of information displayable on a display of the console unit at a time is limited, it is not preferable to simultaneously display the control-progressing states of all the units on the display. Therefore, one of function display screens, which are screen data appropriately configured on a function basis, may be displayed. When it is desired to display another function, a navigation button or the like needs to be used to switch the display to a function display screen that is screen data shown by the other function.

Here, consider the case where a problem such as a malfunction occurs in the wafer stage drive unit while a wafer is being exposed, for example. If the state of the wafer stage drive unit, which is the source of the problem, is being displayed on the console, a positional relationship in the unit of the wafer stage in which the malfunction has been detected is drawn as a schematic diagram along with an alarm message. This allows an operator to visually recognize the occurrence of an alarm factor and the situation of the occurrence of the alarm factor, thereby quickly and properly knowing the cause of the problem.

However, if a function display screen other than the one for the wafer stage drive unit is being displayed at the occurrence of the problem in the wafer stage drive unit, the positional relationship in the unit of the wafer stage in which the malfunction has been detected cannot be drawn as a schematic diagram. Therefore, conventionally, an alarm message is displayed in a status display area within the display to inform the operator of the occurrence of an alarm factor. In this case, the operator first has to suspend work on the currently selected function and identify which unit is the source of the alarm factor from the alarm message. The operator then has to appropriately operate the navigation button to switch the display to the function display screen for the function showing the unit in which the alarm factor is occurring. Thus, the problem has been that, at the occurrence of an alarm factor, the operator cannot immediately visually recognize the situation of the occurrence of the alarm factor.

With the method described in Japanese Patent No. 3031888, a still image of a specific site shot at the time of detection can be recorded. However, it is difficult to properly and quickly recognize the situation of the occurrence of an alarm factor by simply shooting the state of the apparatus at the specific site. It is desired to record not only the actually shot image but also other necessary information at the same time.

### SUMMARY OF THE INVENTION

According to one aspect of the present invention, a screen data processing apparatus comprises a plurality of processing units, a generation unit configured to generate screen data on a processing unit basis in which an execution situation of each processing unit is drawn as a pattern visually recognizable to a user, a display unit configured to display the screen data, a selection unit configured to allow selection as to which screen data generated on a processing unit basis is to be displayed on the display unit, a detection unit configured to detect an event occurring in each processing unit, and a determination unit configured to determine whether or not a processing unit corresponding to the screen data being displayed on the display unit matches a source processing unit of the event when the detection unit detects the event, wherein when the determination unit determines a mismatch, the generation unit generates reduced screen data in which screen data corresponding to the source processing unit is reduced in display size, and the display unit displays the reduced screen data combined with a portion of the screen data being displayed.

According to another aspect of the present invention, a screen data processing apparatus comprises a plurality of processing units, a generation unit configured to generate screen data on a processing unit basis in which an execution situation of each processing unit is drawn as a pattern visually recognizable to a user, a detection unit configured to detect an event occurring in each processing unit, and a storage unit configured to store information about a situation of the occurring event, wherein when the detection unit detects the event, the generation unit generates reduced screen data in which screen data corresponding to a source processing unit of the event is reduced in display size, and the storage unit stores the reduced screen data in association with the information about the situation of the event.

According to still another aspect of the present invention, a screen data processing method in a screen data processing apparatus is provided. The apparatus comprises a plurality of processing units, a generation unit configured to generate screen data on a processing unit basis in which an execution situation of each processing unit is drawn as a pattern visually recognizable to a user, a display unit configured to display the screen data, a selection unit configured to allow selection as to which screen data generated on a processing unit basis is to be displayed on the display unit, and a detection unit configured to detect an event occurring in each processing unit. The method comprises a determination unit determining whether or not a processing unit corresponding to the screen data being displayed on the display unit matches a source processing unit of the event when the detection unit detects the event, the generation unit generating reduced screen data in which screen data corresponding to the source processing unit is reduced in display size when a mismatch is determined in the determining, and the display unit displaying the reduced screen data combined with a portion of the screen data being displayed.

According to yet another aspect of the present invention, a screen data processing method in a screen data processing apparatus is provided. The apparatus comprises a plurality of processing units, a generation unit configured to generate screen data on a processing unit basis in which an execution situation of each processing unit is drawn as a pattern visually recognizable to a user, a detection unit configured to detect an event occurring in each processing unit, and a storage unit configured to store a situation of the occurring event. The method comprises the generation unit generating reduced screen data in which screen data corresponding to the source processing unit of the event is reduced in display size when the detection unit detects the event, and the storage unit storing the reduced screen data in association with information about the situation of the event.

Further features of the present invention will become apparent from the following description of exemplary embodiments (with reference to the attached drawings).

### BRIEF DESCRIPTION OF THE DRAWINGS

FIG. 1 is a schematic diagram showing an exemplary configuration of a semiconductor exposure apparatus according to an embodiment of the present invention;

FIG. 2 is a schematic diagram showing an exemplary configuration of a state display unit according to an embodiment of the present invention;

FIG. 3 is a schematic diagram showing an exemplary basic configuration of a control-progressing state screen displayed on an operation panel 201 according to a first embodiment of the present invention;

FIG. 4A is a schematic diagram showing an exemplary display in the control-progressing state screen 301 according to the first embodiment of the present invention;

FIG. 4B is a schematic diagram showing another exemplary display screen in the case where an event relevant to a function area being displayed in the control-progressing state screen 301 occurs according to the first embodiment of the present invention;

FIG. 5 is a schematic diagram showing an exemplary display screen in the case where an event relevant to a function area different from the function area being displayed in the control-progressing state screen 301 occurs according to the first embodiment of the present invention;

FIG. 6 is an exemplary flowchart showing a procedure of generating the control-progressing state screen at the occurrence of an event according to the first embodiment of the present invention;

FIG. 7 is a schematic diagram showing an exemplary event log list function screen according to the first embodiment of the present invention;

FIG. 8 is a schematic diagram showing an exemplary control-progressing state screen according to the first embodiment of the present invention;

FIG. 9 is an exemplary flowchart showing a procedure of generating the control-progressing state screen at the occurrence of an event according to a second embodiment of the present invention;

FIG. 10 is a schematic diagram showing an exemplary event log storage table according to the second embodiment of the present invention;

FIGS. 11A and 11B are schematic diagrams showing exemplary event log list function screens according to the second embodiment of the present invention;

FIG. 12 is a flowchart for describing manufacture of devices using the exposure apparatus; and

FIG. 13 is a detailed exemplary flowchart of wafer processes in step S1204 in the flowchart shown in FIG. 12.

### DESCRIPTION OF THE EMBODIMENTS

The present invention is applied to a screen data processing apparatus that performs a plurality of processing steps and displays the execution situation of each processing step on a display unit such as a display. With reference to the drawings, the following embodiments will be described particularly for the case where the present invention is applied to a semiconductor exposure apparatus that is an example of such a screen data processing apparatus.

### First Embodiment

In the semiconductor exposure apparatus according to this embodiment, units corresponding to functions that cooperate include a wafer stage device, an alignment detection device, a reticle stage drive device, a light source device, a shutter drive device, a focus detection device, a Z-axis drive device, a reticle transport device, and a wafer transport device.

These units are controlled based on various kinds of control data called recipe parameters. To increase the manufacturing efficiency, these units operate simultaneously and in parallel with each other to perform a plurality of manufacturing processes at the same time. The progressing situation of control operation in these units is monitored by various types of sensors in real time. The progressing situation of control operation in a unit selected by an operator is drawn on a display on a console unit as a visually recognizable pattern that utilizes a schematic diagram, a table, and so on. Predetermined events may be detected with respect to the progressing situation of control operation in a unit related to a function not selected by the operator. In that case, reduced screen data (hereinafter simply referred to as a reduced screen) is generated and displayed on the display, in which a display screen that would be displayed if that function had been selected by the operator is provided with a reduced display size.

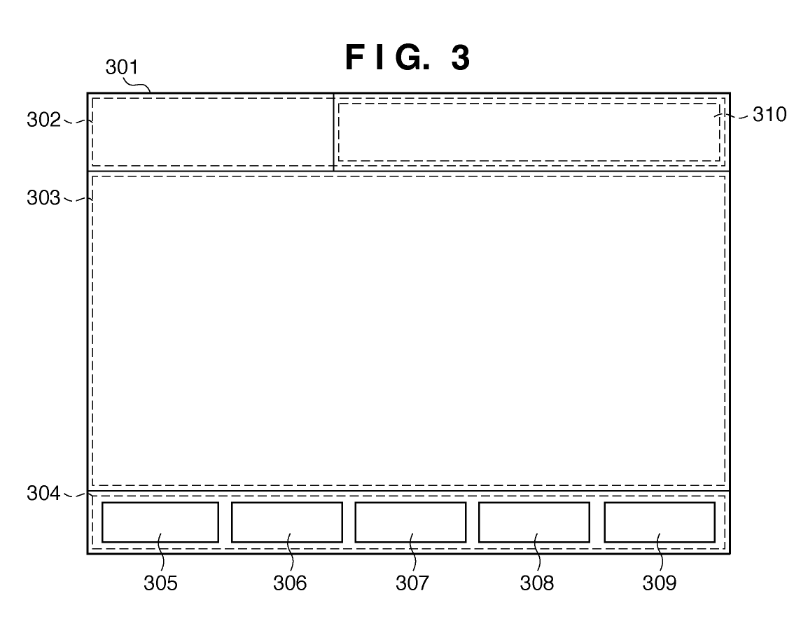

The reduced screen is displayed in a portion of a predefined message display area (310 in FIG. 3 to be described later). Alternatively, the reduced screen may be overlaid on a button used for the operator to indicate which function to select.

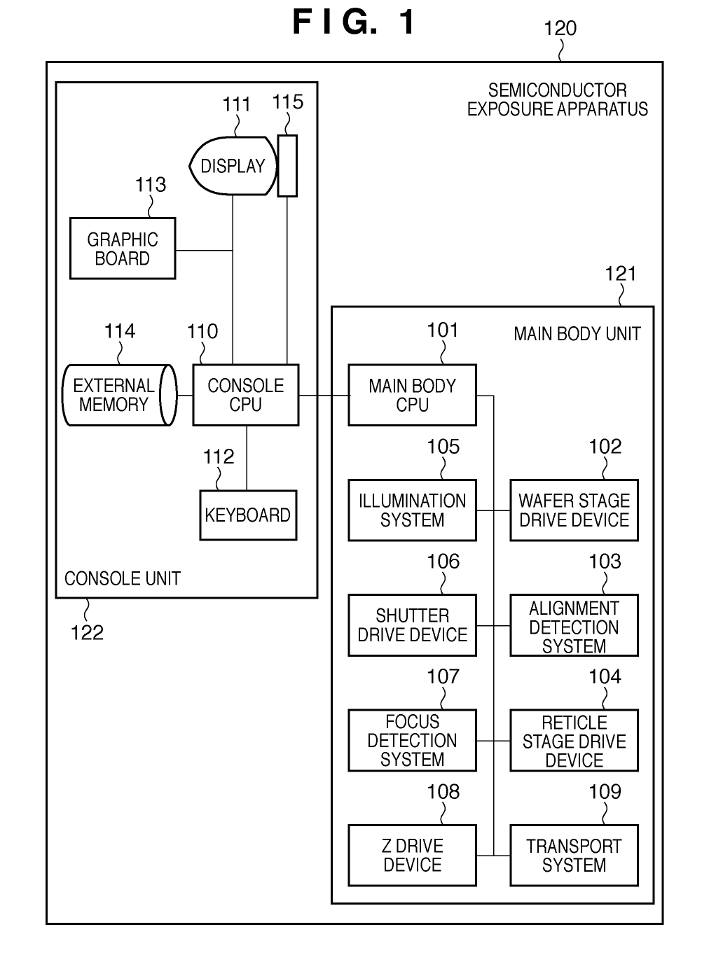

FIG. 1 is a block diagram showing an exemplary electric circuit configuration of a semiconductor exposure apparatus 120 in this embodiment. The semiconductor exposure apparatus 120 includes a main body unit 121 with a CPU controlling the main body unit, and a console unit 122 that displays predetermined information about the apparatus.

The main body unit 121 includes the following components. A main body CPU 101 is internal to the main body unit 121 and responsible for generally controlling the semiconductor exposure apparatus 120. The main body CPU 101 includes a central processing unit such as a microcomputer or minicomputer. The main body unit 121 further includes a wafer stage drive device 102, a reticle stage drive device 104, a shutter drive device 106, and a Z drive device 108. The main body unit 121 also includes an alignment detection system 103 such as an off-axis microscope, an illumination system 105, a focus detection system 107, and a transport system 109 such as a wafer transport device. Operation of these devices and systems will not be described in detail. These devices and systems in the main body unit 121 are simultaneously controlled by the main body CPU 101 in parallel.

The console unit 122 provides various kinds of commands and parameters related to the operation of this exposure apparatus to the main body CPU 101. The console unit 122 includes a console CPU 110, a display 111, a keyboard (an input unit or an input device) 112, and a graphic board 113. The console CPU 110 is responsible for controlling the console unit 122 and may also be called a processing unit, an operation unit, or a processor. A drawing instruction from the console CPU 110 is provided to the graphic board 113, which draws graphics representing the control state on the display 111. The display 111 has a touch sensor 115 capable of graphic display and notifies the console CPU 110 that an object drawn on the display 111 is designated. The display 111 may also be called a display unit or a display device. An external memory 114 such as a hard disk has a database constructed therein and stores various kinds of recipe parameters and their management data, as well as operator groups and so on. The recipe parameters include reticles used, the aperture of a masking blade, the exposure, layout data, and so on. The external memory 114 also stores an event log storage table, compressed image data files of screens, and so on, as described later. Instead of or in addition to the touch sensor 115, a designation unit such as a pointing device may be provided.

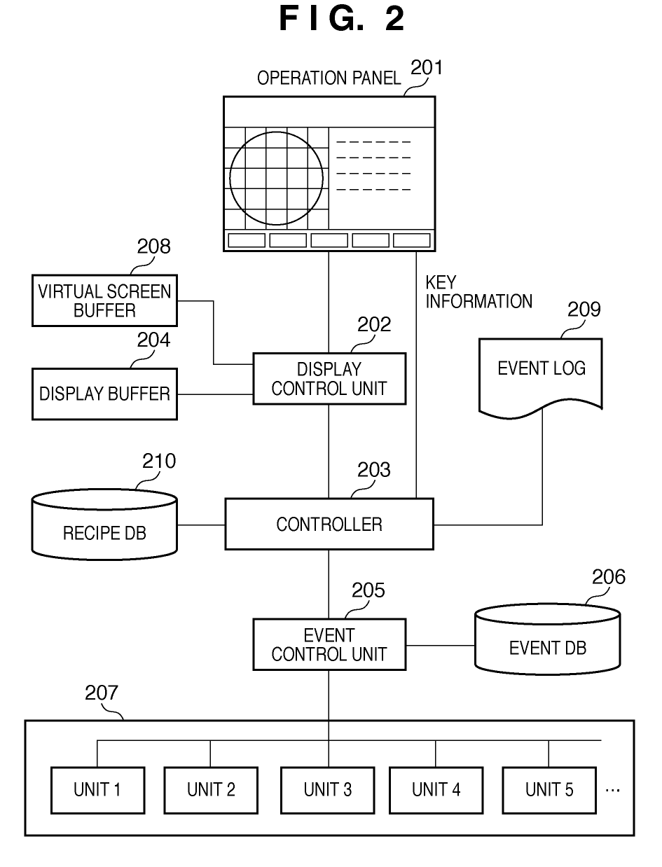

FIG. 2 is a diagram for describing an exemplary configuration of a state display unit in a control device of this semiconductor exposure apparatus. This state display unit is implemented in the console unit 122. In FIG. 2, an operation panel 201 is composed of the above-described display 111 and touch sensor 115.

A display control unit 202 receives various kinds of information and data from a controller 203 and controls display on the operation panel 201. The controller 203 identifies information to be drawn on the operation panel 201 based on input information from the operation panel 201 and instructs the display control unit 202 to draw the control-progressing state. An event control unit 205 monitors the state of each unit and detects events. An event herein refers to a specific control-progressing state. Exemplary events include the occurrence of an error, the start of a job, and so on that occur depending on the execution situation of processing.

The controller 203 also obtains an event occurrence notification and an event situation from the event control unit 205. The event situation herein refers to information identifying an occurring event and includes an event code, an event message, an event occurrence time, unit-specific information, and so on. The controller 203 then determines whether a unit for which information is being displayed on the operation panel 201 is the event source unit, and generates an appropriate control state display screen in a display buffer 204 by a method to be described later. Thereafter, the controller 203 notifies the display control unit 202 of the event to be displayed on the operation panel 201.

The display control unit 202 also generates a virtual screen to be described later in a virtual screen buffer 208. The display buffer 204 and the virtual screen buffer 208 save the screens generated by the display control unit 202.

The event control unit 205 detects an event occurring in each unit 207 and searches an event DB (database) 206 for an event code corresponding to the event. The event control unit 205 then notifies the controller 203 of the event situation including the obtained event information. The event DB 206 is a database that stores event information such as event types, event codes, event messages, how to address events, and event levels.

The units 207 are units that control the semiconductor manufacturing apparatus. An event log 209 is an event log file or DB for storing a history of events that occurred. Stored in the event log 209 as history information is event situation data including event types, dates, times, unit-specific information, codes, and details. A recipe DB 210 is a DB for managing recipes. The controller 203 controls the event control unit 205 based on a recipe obtained from the recipe DB 210.

FIG. 3 shows an exemplary configuration of a control-progressing state screen 301 displayed on the operation panel 201. By referring to the control-progressing state screen 301, a user can recognize the state of the semiconductor exposure apparatus.

A title panel 302 is a panel displaying the title of the control-progressing state screen 301 and includes a message display area 310 displaying a message about an occurring event.

An information area 303 displays one or more information or graphic screens presenting information about each function. In a preferable example, the information area 303 occupies the largest part in the control-progressing state screen 301. The navigation panel 304 has navigation buttons 305 to 309 each disposed with a character label or icon representing the type of each function. Pressing one of the buttons causes information about the corresponding function to be displayed in the information area 303. Although five navigation buttons are disposed in the navigation panel 304 in this example, more or fewer buttons may be disposed depending on the number of functions to be displayed. One navigation button corresponds to one function. Dashed lines in the figure schematically represent the relationship among each area and are not necessarily displayed in the actual screen.

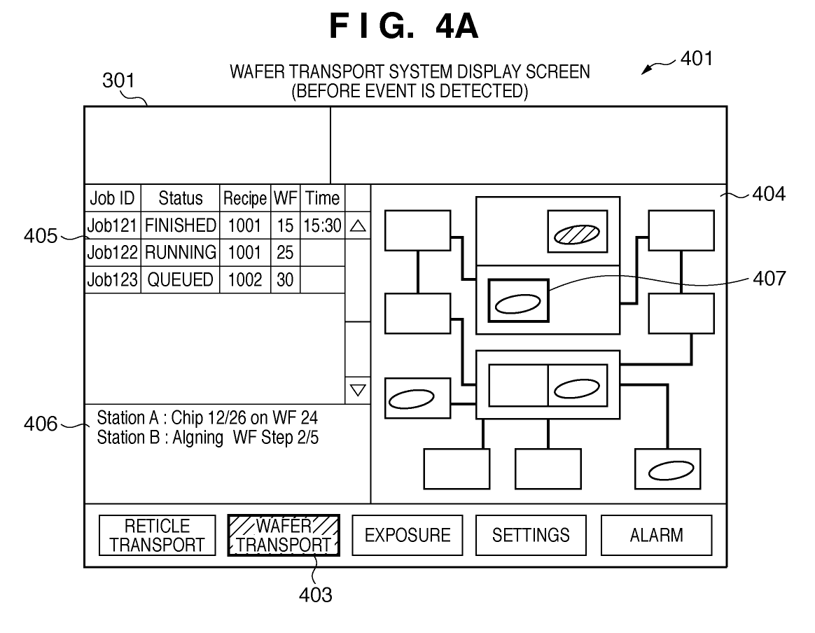

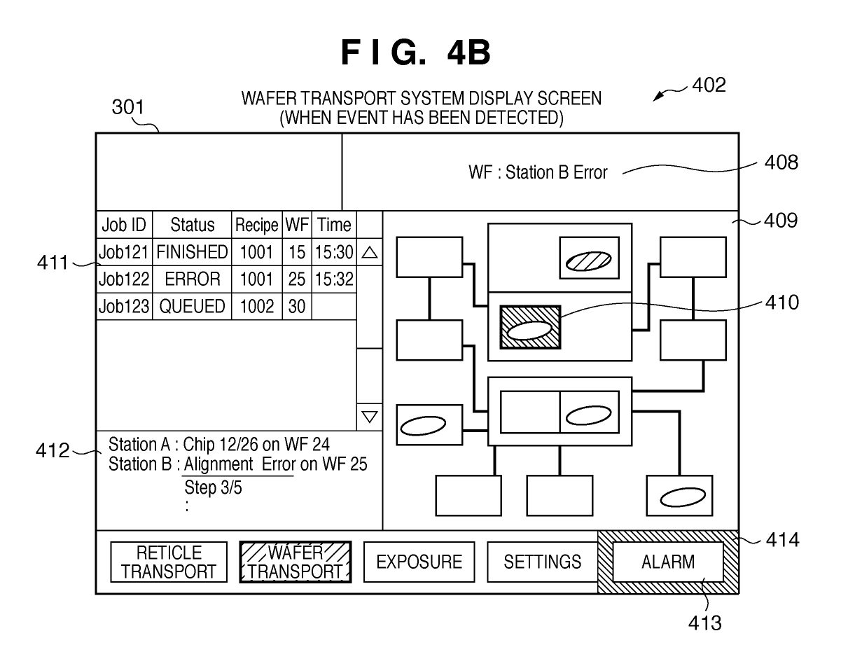

FIGS. 4A and 4B are diagrams showing an exemplary wafer transport system display screen. In this embodiment, a function displaying the state of the wafer transport system is referred to as a wafer transport system display function. The control-progressing state screen 301 in which the wafer transport system display function is selected and information related to the wafer transport system display function is displayed in the information area 303 is referred to as a wafer transport system display screen.

A wafer transport system display screen 401 shown in FIG. 4A illustrates a display example where a navigation button 403 has been pressed to select the wafer transport system display function. The navigation button 403 is highlighted for differentiation from the other buttons, thereby indicating that the wafer transport system display function is being selected.

The information area 303 displays elements of the information related to the wafer transport system display function: a wafer transport path schematic diagram 404, a transport job list 405, and a transport job status details area 406. In the case of the wafer transport system display function, the wafer transport path schematic diagram 404 generated beforehand is updated in real time according to the situation of the wafer transport system. The transport job list 405 is also updated according to the progressing situation of jobs. Further, details of statuses of the jobs shown in the transport job list 405 are displayed in the transport job status details area 406.

The location of a wafer being controlled is indicated by a wafer stage schematic diagram 407 in the wafer transport path schematic diagram 404.

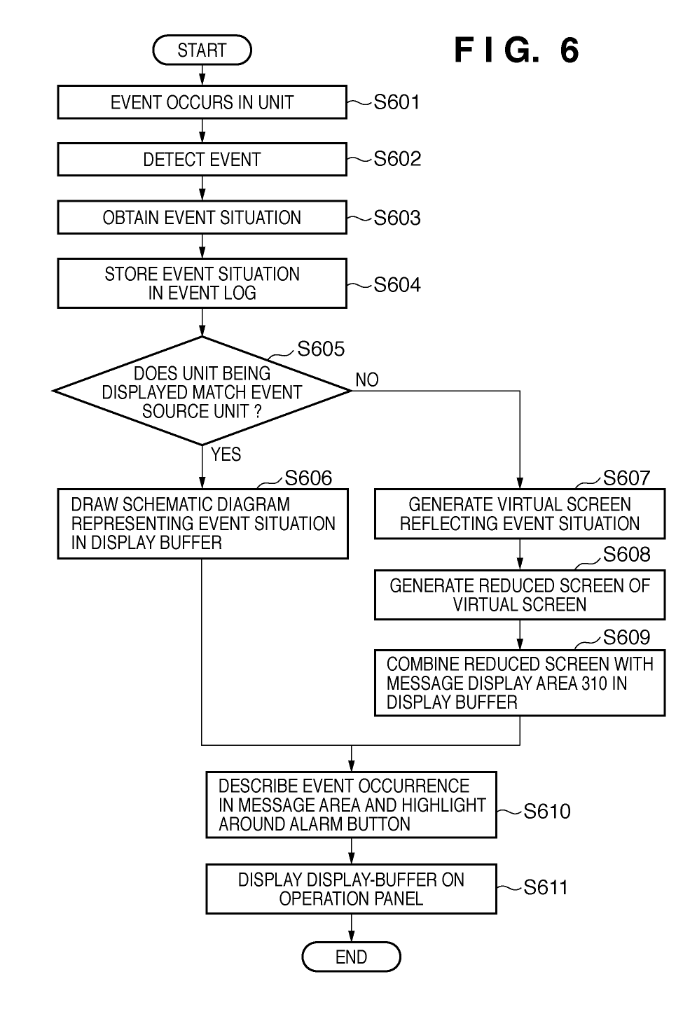

Now, with reference to FIG. 6, a procedure of generating the control-progressing state screen at the occurrence of an event according to the embodiment of the present invention will be described. FIG. 6 is an exemplary flowchart showing the procedure of generating the control-progressing state screen at the occurrence of an event. Processing in this flowchart is performed by the console CPU 110 executing a computer program read from the external memory 114.

With reference to FIGS. 4A, 4B, and 6, description will be given of screen drawing in the case where an event occurs in a unit related to a function being displayed in the control-progressing state screen 301.

First, in step S601, it is assumed that an error event occurs in the unit 207 of the wafer transport system while the wafer transport system display screen 401 is being displayed.

In step S602, the event control unit 205 detects the occurrence of the event. Thereafter, in step S603, the event control unit 205 obtains the event situation of the detected event and notifies the controller 203 thereof.

In step S604, the controller 203 stores the event situation in the event log 209 and recognizes that the event situation should be displayed in the wafer transport system display screen.

In step S605, the controller 203 determines whether or not the unit being displayed matches the event source unit. In this example, the screen being displayed in the control-progressing state screen 301 is the wafer transport system display screen 401 showing the wafer transport system, which is exactly the event source unit (“YES” in step S605).

Therefore, in step S606, the controller 203 uses the display control unit 202 to generate, in the display buffer 204, a screen that draws the event situation. With reference to FIG. 4B, a wafer transport system display screen 402 at the detection of the event will be described. In the wafer transport path schematic diagram 404, the display control unit 202 draws a wafer stage 410 indicating an event detection location in the wafer transport path by coloring the wafer stage schematic diagram 407 with a color indicating the detection of the event. The display control unit 202 also rewrites the display of the transport job list 411 and the transport job status details area 412 with descriptions indicating the detection of the event and the event details, respectively.

Returning to FIG. 6, in step S610, the display control unit 202 writes, in the message display area 310 in the display buffer 204, an event message 408 that informs the operator of the detection of the event and the description of the detected event. At the same time, the display control unit 202 draws a highlighted area 414 around an alarm button 413. The color of the highlighted area 414 may vary depending on the degree of importance of the event.

Finally, in step S611, the display control unit 202 displays on the operation panel 201 the wafer transport system display screen 402 saved in the display buffer 204. Thus, the operator can be informed of the presence of the detected event.

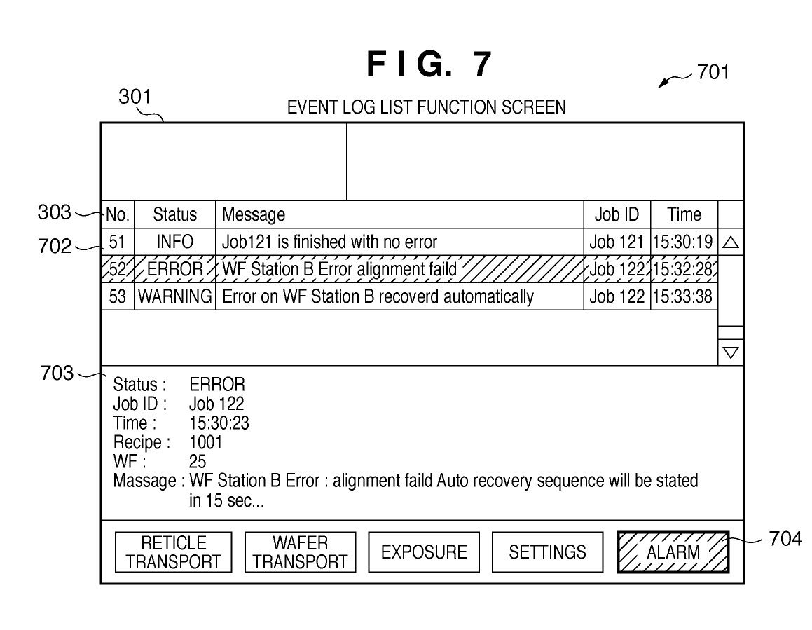

At this point, pressing the alarm button 413 causes an event log list function to be selected in place of the wafer transport system display function being selected so far, as shown in FIG. 7. As a result, an event log list function screen 701 is displayed that shows event situations based on the history information stored in the event log 209. The information area 303 in the event log list function screen 701 displays an event log list 702 and a details area 703 that indicates details of a selected event situation. At the same time, the alarm button 704 is highlighted to indicate that the function being selected is the event log list function.

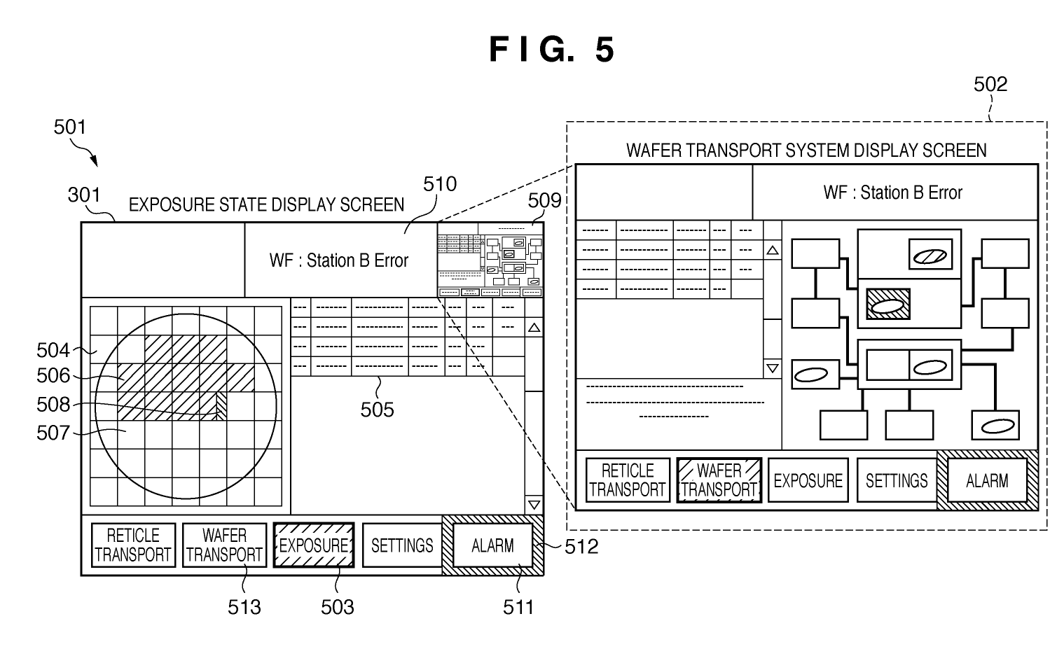

Now, with reference to FIGS. 5 and 6, description will be given of screen drawing in the case where an event occurs in a unit different from a unit being displayed in the control-progressing state screen 301.

FIG. 5 is a schematic diagram showing an exemplary display screen in the case where an event occurs in a unit different from a unit being displayed in the control-progressing state screen 301.

An exposure state display screen 501 is an example where a navigation button 503 has been pressed to select an exposure state display function for the control-progressing state screen 301. The exposure state display function herein refers to a function displaying information about the state of exposure. The navigation button 503 is highlighted for differentiation from the other buttons, thereby indicating that the exposure state display function is being selected. The information area 303 displays elements of the information related to the exposure state display function: an exposed wafer schematic diagram 504 and an exposure job list 505.

The exposed wafer schematic diagram 504 shows a display 506 of chips that have been exposed and a display 507 of chip portions not yet to be exposed. A current reticle position 508, which is the portion being exposed, is also displayed.

It is assumed that an error event occurs in step S601 of FIG. 6 in the unit 207 of the wafer transport system while the exposure state display screen 501 is being displayed.

Processing as in the above description of the example with reference to FIG. 4 is performed, so that the controller 203 recognizes that the event situation should be displayed in the wafer transport system display screen. However, the screen being displayed in the control-progressing state screen 301 is the exposure state display screen 501 showing a unit different from the event source unit. Therefore, in step S605, it is determined that the wafer transport system display screen 402 cannot be displayed in the control-progressing state screen 301 (“NO” in step S605).

In step S607, the controller 203 therefore uses the display control unit 202 to generate in the virtual screen buffer 208 a wafer transport system virtual screen 502. The wafer transport system virtual screen 502 refers to a screen that would be displayed in the control-progressing state screen 301 if the wafer transport system display function had been selected, and it is a screen like the wafer transport system display screen 402, for example. That is, this virtual screen is generated in the same manner as the normal control state display screen. The wafer transport system virtual screen 502 reflects the event situation obtained in step S603 and includes display content that would be otherwise displayed as the wafer transport system display screen 402. This display content includes the wafer transport path 409 representing the event situation, the event message 408, the highlighted area 414 around the alarm button, and so on.

In step S608, the display control unit 202 generates a reduced screen 509 showing a reduced version of the wafer transport system virtual screen 502. Any known resolution changing techniques may be used to generate the reduced screen. In step S609, the display control unit 202 combines the reduced screen 509 with the message display area 310 in the display buffer 204.

In step S610, as in the example described for FIG. 4, the display control unit 202 writes, in the message display area 310 of the screen saved in the display buffer 204, an event message 510 that informs the operator of the detection of the event and the description of the detected event. The display control unit 202 also draws a highlighted area 512 around an alarm button 511.

Finally, in step S611, the display control unit 202 displays on the operation panel 201 the exposure state display screen 501 saved in the display buffer. Thus, the display control unit 202 can inform the operator of the presence of the detected event.

At this point, pressing the alarm button 511 causes the event log list function screen 701 shown in FIG. 7 to be displayed in place of the information related to the currently displayed function.

With the above-described procedure, even at the occurrence of an event in a unit different from a unit being displayed in the control-progressing state screen 301, a reduced screen of a control-progressing state screen showing the event source unit can be displayed in the control-progressing state screen 301. This allows the operator to visually recognize the situation of the occurrence of the event without switching the screen display to a function displaying the state of the event source unit, thereby quickly addressing the occurring event.

Assume that the control-progressing state screen for each function displays the state of the unit at the time when the operator notices and checks the occurrence of an event. In that case, even if the display is switched to the relevant function display screen, the situation may have already changed and a drawing screen at the time of the occurrence of the event may not be able to be obtained. In contrast, the reduced screen obtained in this embodiment is a snapshot of the function display screen at the time of the occurrence of the event. This provides an advantage of the ability to readily recognize the situation at the time of the occurrence of the event.

In the above embodiment, in FIG. 5, the reduced screen 509 showing the reduced version of the wafer transport system virtual screen 502 is displayed in the message display area 310. Alternatively, the reduced screen 509 may be displayed at the location of the navigation button 513 used to designate switching to the function displaying the situation of the wafer transport system, which is the event source.

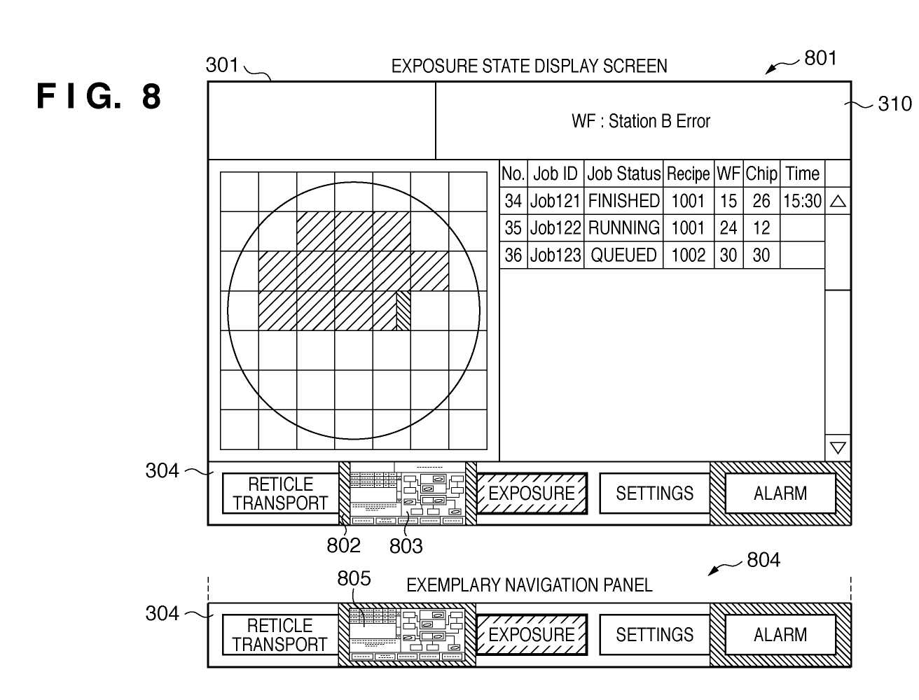

FIG. 8 is a diagram showing this state. Since the display area of the navigation button 513 is limited in size, a reduced screen 803 showing the reduced version of the wafer transport system virtual screen 502 with a modified aspect ratio is displayed in the exposure state display screen 801. Also, to emphasize that the event source is the wafer transport system, the reduced screen 803 is overlaid on a highlighted area 802 drawn around the navigation button 513.

As shown in an exemplary navigation panel 804, rather than reducing the entire wafer transport system virtual screen 502, a partial reduced screen 805 showing a reduced screen of a portion corresponding to the information area 303 may be displayed at the location of the navigation button. In that case, although the partial reduced screen 805 does not include information about portions corresponding to the title panel 302 and the navigation panel 304, this information can be compensated for with corresponding portions of the exposure state display screen 801 itself.

Further, a function may be selected by directly designating with a shortcut key or the like through the input unit such as a keyboard. In that case, the navigation panel 304 and the navigation buttons 305 to 309 may not be displayed in the control-progressing state screen 301.

Thus, since the reduced screen data 803 or the partial reduced screen data 805 is displayed at the location of the navigation button, the operator can more quickly recognize the situation of the event source unit. This allows the operator to quickly perform an operation of changing the screen to the corresponding function.

### Second Embodiment

The first embodiment has been described about the method of calling the operator's attention and prompting the operator to address quickly at the occurrence of an event.

In an actual semiconductor exposure apparatus, control operation for the manufacturing processes including more than ten thousands of steps is performed in order to carry out one job unit, and many events can occur asynchronously. Therefore, it is effective for an increased manufacturing efficiency to properly determine event occurrence situations by using the methods as illustrated in the first embodiment and limit the operator's intervention to only when fatal error events occur. On the other hand, if the operator does not intervene, detailed investigation of an event occurring in each manufacturing process must be performed asynchronously with the manufacturing process. Now, another embodiment of the present invention, which is effective in performing such investigation and facilitates visual recognition of details of an occurring event, will be described below.

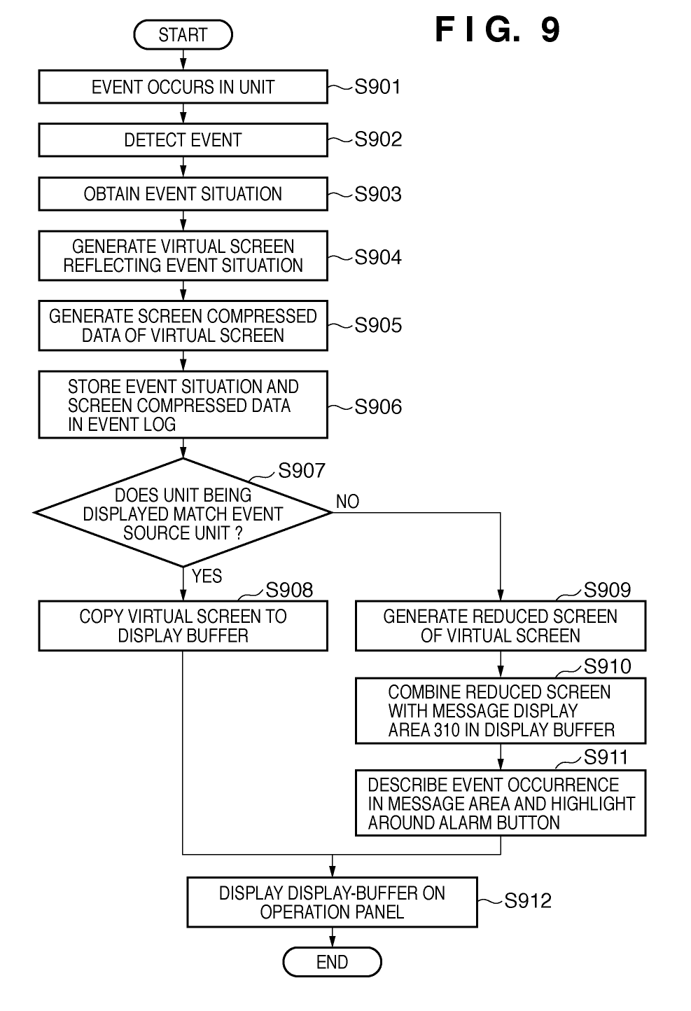

FIG. 9 is an exemplary flowchart showing operations at the occurrence of an event. Now taking again the situation of FIG. 5 as an example, description will be given with reference to FIG. 9 of screen drawing in the case where an event occurs in a unit different from a unit being displayed in the control-progressing state screen 301. Processing in this flowchart is performed by the console CPU 110 executing a computer program read from the external memory 114.

It is assumed that an error event occurs in step S901 in the unit 207 of the wafer transport system while the exposure state display screen 501 is being displayed.

In step S902, the event control unit 205 detects the occurrence of the event. Then in step S903, the event control unit 205 obtains the event situation.

In step S904, the controller 203 uses the display control unit 202 to generate, in the virtual screen buffer 208, the wafer transport system virtual screen 502 that reflects the event situation obtained in S903. Then in step S905, the controller 203 generates screen compressed data by converting the wafer transport system virtual screen 502 to compressed image data. Further in step S906, the controller 203 stores the event situation and the screen compressed data in association with each other in the event log 209 as described later.

In step S907, the controller 203 determines whether or not the unit being displayed in the control-progressing state screen 301 matches the event source unit. If it matches (“YES” in step S907), the controller 203 copies the generated virtual screen from the virtual screen buffer 208 to the display buffer 204 in step S908.

However, in this example, the screen being displayed in the control-progressing state screen 301 is the exposure state display screen 501 showing a unit different from the event source unit (“NO” in step S907). Therefore, in step S909, the controller 203 generates the reduced screen 509 showing a reduced version of the generated wafer transport system virtual screen 502. Then in step S910, the controller 203 combines the reduced screen 509 with the message display area 310 in the display buffer 204.

Next, as in the example described in the embodiment of FIG. 1, in step S911, the display control unit 202 writes, in the message display area 310 in the display buffer 204, the event message 510 that informs the operator of the detection of the event and the description of the detected event. The display control unit 202 also draws the highlighted area 512 around the alarm button 511.

Finally, in step S912, the display control unit 202 displays on the operation panel 201 the exposure state display screen 501 drawn in the display buffer.

It is to be noted that, in step S908, rather than copying the virtual screen from the virtual screen buffer 208, the controller 203 may directly perform drawing representing the event situation in the display buffer 204 as in steps S605 and S609 described in the first embodiment.

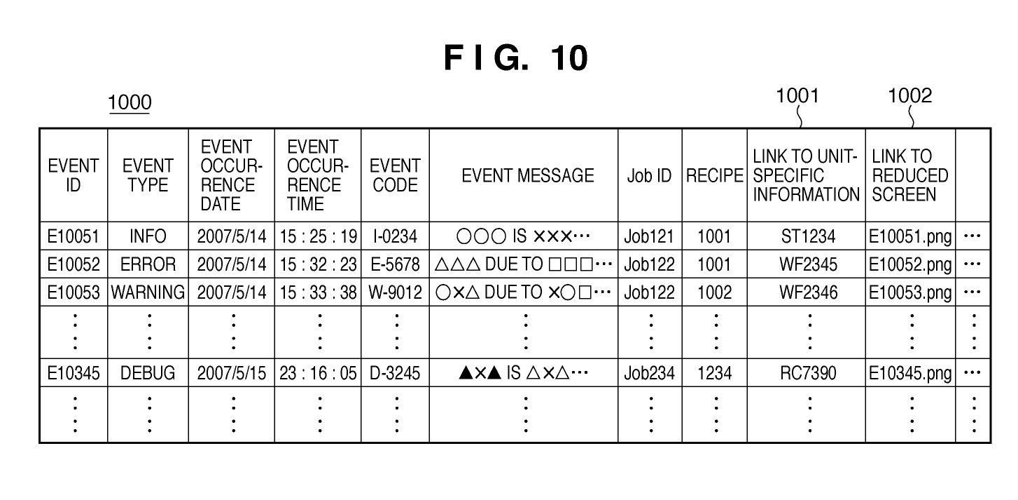

The event log 209 consists of an event log storage table 1000 and screen compressed data files (not shown). FIG. 10 is a schematic diagram showing an example of the event log storage table 1000 included in the event log 209. Stored in the event log storage table 1000 as history information is event situation data, including event types, dates, times, links 1001 to unit-specific information, event codes and messages, and links 1002 to screen compressed files.

The links 1001 to unit-specific information are links to control-progressing information specific to each function. A unit-specific information table (not shown) stores the control-progressing information specific to each function and is linked from the event log storage table 1000. On the other hand, the links 1002 to screen compressed files are links to reduced screens at the time of the occurrence of corresponding events. The screen compressed data is stored as image data files in a compression format such as PNG, such that each file name includes the event ID as its base name. The compression format for the screen compressed data is not limited to PNG mentioned above as an example but may be other image compression formats such as JPEG.

It is to be noted that in step S905, a reduced screen of the virtual screen may first be generated and then this reduced screen may be compressed to generate the screen compressed data. Description of the other items will be omitted.

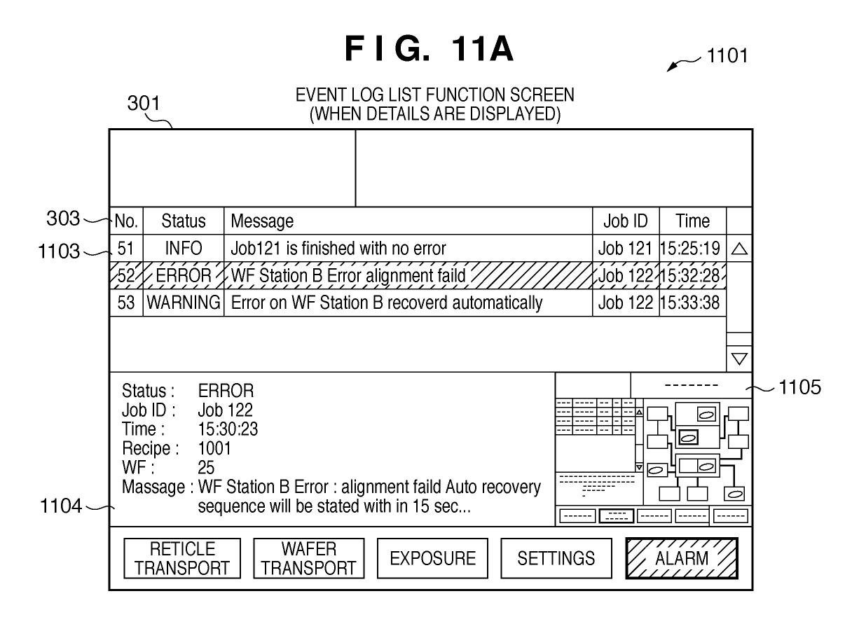

Now, with reference to exemplary event log list function screens shown in FIGS. 11A and 11B, the event log list function in this embodiment will be described. In an event log list function screen 1101, as in the event log list function screen 701 in FIG. 7, an event log list 1103 is displayed in the information area 303 and details of a selected event situation is displayed in a details area 1104. Event situation data stored in the event log storage table 1000 containing the unit-specific information is displayed in the details area 1104. Correspondingly, a reduced screen 1105 is also displayed that shows a reduced version of screen data stored in a screen compressed file linked from the event log storage table.

Thus, as described above, in this embodiment, the operator can be informed of the presence of the detected event, and the reduced screen is also stored as an image in the event log along with the event situation. The image of this reduced screen is a snapshot of the function area display screen in which the event situation at the time of the occurrence of the event is drawn. This provides an advantage of facilitating the operator's visual recognition of the situation at the time of the occurrence of the event when the operator analyzes the event log.

Although the above-described embodiments illustrate examples in which an error event is detected, events are not limited to errors. For example, log events may be provided as part of the recipe parameters stored in the recipe DB and may be used for recording the control-progressing situation at any timing. This provides an advantage of facilitating visual recognition of the control-progressing situation of the entire semiconductor exposure apparatus in more detail.

Although the above-described embodiments use the touch sensor 115 shown in FIG. 1 as the pointing device, it is of course possible to use a mouse or the like. If a mouse is used as the pointing device, a mouse pointer 1106 may be used to indicate a designated position on the screen as shown in an event log list function screen 1102, for example. When the operator designates one event item from an event log list 1107 with the mouse pointer 1106, a reduced screen 1108 showing a reduced version of a screen compressed file linked from the designated event may be displayed overlapping the event log list function screen 1102. In this manner, the operator can visually recognize the outline of the event before displaying the details area, and this provides an advantage of being able to more quickly find an event requiring detailed investigation.

### Third Embodiment

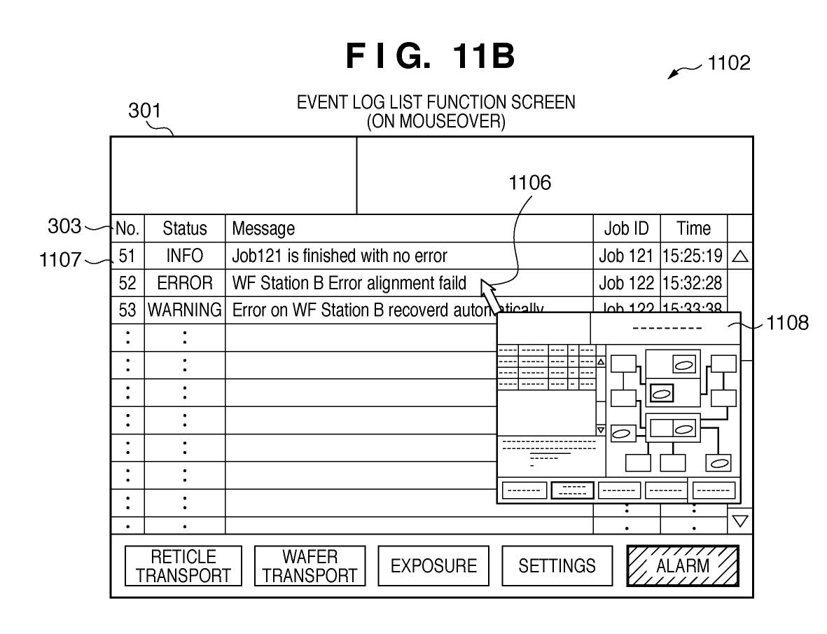

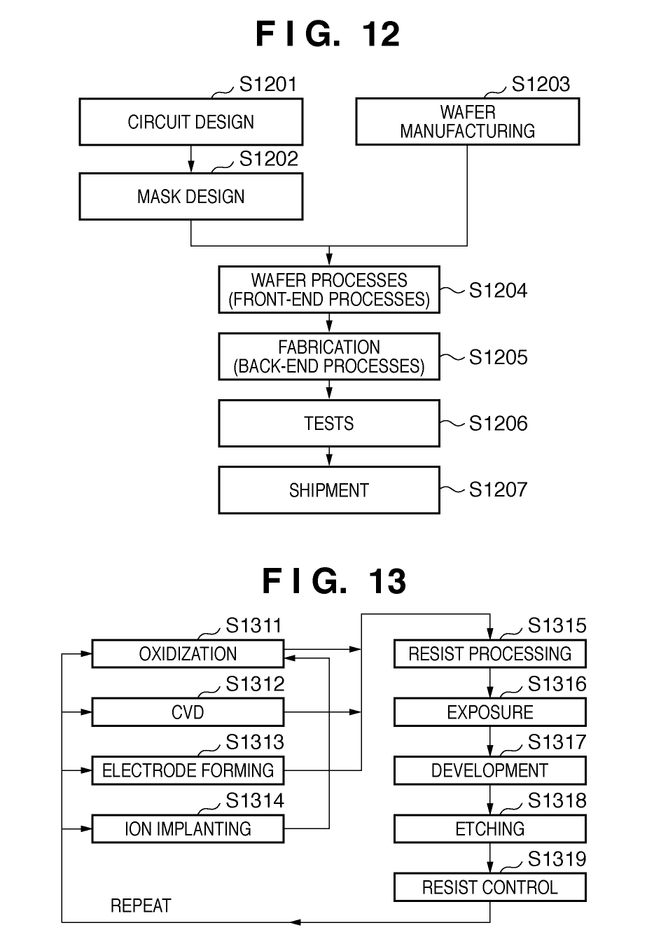

Now, with reference to FIGS. 12 and 13, an embodiment of the above-described semiconductor manufacturing apparatus will be described. FIG. 12 is a flowchart for describing manufacture of devices (semiconductor chips (such as ICs and LSIs), LCDs, CCDs, etc.). Here, description will be given of a method of manufacturing semiconductor chips as an example.

In step S1201, a semiconductor device circuit is designed. In step S1202, masks (also called original plates or reticles) are produced based on designed circuit patterns. In step S1203, a wafer (also called a substrate) is manufactured using a material such as silicon. Step S1204 is called front-end processes, in which the masks and the wafer are used to form the actual circuit on the wafer by a lithography technique in the above-described exposure apparatus. Step S1205, which is called back-end processes, are processes of making semiconductor chips using the wafer produced in step S1204 and include fabrication processes such as an assembly process (dicing and bonding), a packaging process (chip sealing), and so on. In step S1206, tests such as an operation check test and an endurance test are performed on the semiconductor devices produced in step S1205. The semiconductor devices are completed through these processes and shipped in step S1207.

FIG. 13 is a detailed flowchart of the wafer processes in step S1204. In step S1311, the wafer surface is oxidized. In step S1312, an insulating film is formed on the wafer surface. In step S1313, electrodes are formed on the wafer by deposition. In step S1314, ions are implanted in the wafer. In step S1315, the wafer is coated with photoresist. In step S1316, the above-described exposure apparatus is used to expose the wafer through the mask pattern. In step S1317, the exposed wafer is developed. In step S1318, portions other than the developed resist images are removed. In step S1319, the resist no more needed after the etching is stripped. By repeating these steps, circuit patterns are formed in layers on the wafer. These wafer processes are controlled based on parameters described in a procedure manual called a recipe.

### Other Exemplary Embodiments

The above-described exemplary embodiments of the present invention can also be achieved by providing a computer-readable storage medium that stores program code of software (computer program) which realizes the operations of the above-described exemplary embodiments, to a system or an apparatus. Further, the above-described exemplary embodiments can be achieved by program code (computer program) stored in a storage medium read and executed by a computer (CPU or micro-processing unit (MPU)) of a system or an apparatus.

The computer program realizes each step included in the flowcharts of the above-mentioned exemplary embodiments. Namely, the computer program is a program that corresponds to each processing unit of each step included in the flowcharts for causing a computer to function. In this case, the computer program itself read from a computer-readable storage medium realizes the operations of the above-described exemplary embodiments, and the storage medium storing the computer program constitutes the present invention.

Further, the storage medium which provides the computer program can be, for example, a floppy disk, a hard disk, a magnetic storage medium such as a magnetic tape, an optical/magneto-optical storage medium such as a magneto-optical disk (MO), a compact disc (CD), a digital versatile disc (DVD), a CD read-only memory (CD-ROM), a CD recordable (CD-R), a nonvolatile semiconductor memory, a ROM and so on.

Further, an OS or the like working on a computer can also perform a part or the whole of processes according to instructions of the computer program and realize functions of the above-described exemplary embodiments.

In the above-described exemplary embodiments, the CPU jointly executes each step in the flowchart with a memory, hard disk, a display device and so on. However, the present invention is not limited to the above configuration, and a dedicated electronic circuit can perform a part or the whole of processes in each step described in each flowchart in place of the CPU.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-046900, filed Feb. 27, 2008 which is hereby incorporated by reference herein in its entirety.

What is claimed is:

1. A screen data processing apparatus comprising:
a plurality of processing units;
a generation unit configured to generate screen data on a processing unit basis in which an execution situation of each processing unit is drawn as a pattern visually recognizable to a user;
a display unit configured to display the screen data;
a selection unit configured to allow selection as to which screen data generated on a processing unit basis is to be displayed on said display unit;
a detection unit configured to detect an event occurring in each processing unit; and
a determination unit configured to determine whether or not a processing unit corresponding to the screen data being displayed on said display unit matches a source processing unit of the event when said detection unit detects the event, wherein
when said determination unit determines a mismatch, said generation unit generates reduced screen data in which screen data corresponding to said source processing unit is reduced in display size, and
said display unit displays the reduced screen data combined with a portion of the screen data being displayed.

2. The apparatus according to claim 1, wherein said display unit displays the reduced screen data combined with an area on said display unit used for displaying the screen data corresponding to said source processing unit of the event.

3. A screen data processing apparatus comprising:
a plurality of processing units;
a generation unit configured to generate screen data on a processing unit basis in which an execution situation of each processing unit is drawn as a pattern visually recognizable to a user;
a detection unit configured to detect an event occurring in each processing unit; and
a storage unit configured to store information about a situation of the occurring event, wherein
when said detection unit detects the event, said generation unit generates reduced screen data in which screen data corresponding to a source processing unit of the event is reduced in display size, and
said storage unit stores the reduced screen data in association with the information about the situation of the event.

4. The apparatus according to claim 3, further comprising a display unit configured to display a list of information about situations of events stored in said storage unit, wherein
when information about a situation of any event from the list is selected by a user, said display unit displays, along with the information about the situation of the event, the reduced screen data stored in said storage unit in association with the selected information.

5. The apparatus according to claim 3, wherein said storage unit stores the reduced screen data as image data.

6. The apparatus according to claim 3, wherein the reduced screen data is screen data showing a reduced version of an area indicating the situation of the detected event out of the screen data corresponding to said source processing unit.

7. A screen data processing method in a screen data processing apparatus comprising:
a plurality of processing units;
a generation unit configured to generate screen data on a processing unit basis in which an execution situation of each processing unit is drawn as a pattern visually recognizable to a user;
a display unit configured to display the screen data;
a selection unit configured to allow selection as to which screen data generated on a processing unit basis is to be displayed on said display unit; and
a detection unit configured to detect an event occurring in each processing unit, wherein said method comprising:
a determination unit determining whether or not a processing unit corresponding to the screen data being displayed on said display unit matches a source processing unit of the event when said detection unit detects the event;
said generation unit generating reduced screen data in which screen data corresponding to said source processing unit is reduced in display size when a mismatch is determined in said determining; and
said display unit displaying the reduced screen data combined with a portion of the screen data being displayed.

8. The method according to claim 7, wherein in said displaying, the reduced screen data is displayed combined with an area on said display unit used for displaying the screen data corresponding to said source processing unit of the event.

9. A screen data processing method in a screen data processing apparatus comprising:
a plurality of processing units;
a generation unit configured to generate screen data on a processing unit basis in which an execution situation of each processing unit is drawn as a pattern visually recognizable to a user;
a detection unit configured to detect an event occurring in each processing unit; and
a storage unit configured to store a situation of the occurring event, wherein said method comprises:
said generation unit generating reduced screen data in which screen data corresponding to said source processing unit of the event is reduced in display size when said detection unit detects the event; and
said storage unit storing the reduced screen data in association with information about the situation of the event.

10. The method according to claim 9, wherein said apparatus further comprises a display unit configured to display a list of information about situations of events stored in said storage unit, said method further comprising:
said display unit displaying, along with the situation of the event, the reduced screen data stored in said storage unit in association with the selected information when a user selects information about a situation of any event from the list.

11. The method according to claim 9, wherein in said storing, the reduced screen data is stored as image data.

12. The method according to claim 9, wherein the reduced screen data is screen data showing a reduced version of an area indicating the situation of the detected event out of the screen data corresponding to said source processing unit.

13. A computer program stored on a storage medium for causing a computer to function as the apparatus according to claim 1.

14. The apparatus according to claim 1, wherein said screen data processing apparatus is a semiconductor exposure apparatus.
